(19) United States
(12) Patent Application Publication
(10) Pub. No.: US 2002/0165770 A1
(43) Pub. Date: Nov. 7, 2002

(54) Method and system for providing content with an option

(75) Inventors: Denis Khoo, Arcadia, CA (US); Raymond F. Ratcliff III, Plano, TX (US)

Correspondence Address: PILLSBURY WINTHROP, LLP, P.O. BOX 10500, MCLEAN, VA, 22102, US

(73) Assignee: Individual Network, Inc.

(21) Appl. No.: 09/849,495

(22) Filed: May 4, 2001

(51) Int. Cl. G06F 17/60

(52) U.S. Cl. 705/14

(57) ABSTRACT

A method and system is provided for providing content from a content provider to a viewer over a data network. The content is associated with an option to: (1) view content with advertisements during the content for no compensation; or (2) view content without advertisements during the content for compensation.

### BACKGROUND OF THE INVENTION

1. Technical Field

The present invention relates generally to providing content over a data network and, more particularly, to a method and system for providing content with an option of receiving or not receiving advertisements during the content.

1. Description of Related Art

Television broadcasters typically show advertisements or commercials to a television viewer during a program to generate revenues. Viewers are therefore forced to watch these advertisements during a program or must turn a television channel to another program to avoid having to watch the commercial. Thus, in the case of public television broadcasting, the commercials are inseparable from the programs. For example, a typical television program lasting thirty (30) minutes is shown as follows. A first program segment is shown followed by a first commercial, second commercial and even third commercial. Then a second program segment is shown which is again followed by a fourth commercial segment, a fifth commercial segment and a sixth commercial segment, and so on. Thus, in a thirty minute program slot, the program segments account for about 23 minutes worth of programs while the commercial time accounts for approximately 7 minutes of the 30 minute program segment.

This public television paradigm causes numerous problems. First, a viewer's time is wasted since a viewer is forced to watch commercials that the viewer may not wish to watch. Second, since many viewers may turn the television channel when commercials commence, a viewer may miss program segments since the viewer must estimate the appropriate time to return to the television channel showing the program based on when the viewer believes the commercials will end and the program begins. A third problem with this public broadcasting paradigm is that many viewers refuse to watch more television because of the amount of commercials being shown and therefore the viewing audience is decreased. These limitations with public broadcast television have been somewhat alleviated by alternative broadcasting schemes.

One alternative broadcasting scheme is cable television whereby a viewer may pay a fee to receive alternative channels not available to the general public. Some of these channels may provide programs without advertisements such as full length movies that contain no advertisements. However, cable television, in general, and cable movie programs in particular, provide no option whatsoever to a viewer of whether the viewer wishes to view the commercials or not view the commercials. In fact, many cable television stations contain commercials throughout the cable programming and the viewer has no option as to whether or not he/she may view commercials or not view commercials, where the viewer is only required to provide a fee to the cable broadcaster and is left with no options otherwise regarding commercials and programming.

A second alternative broadcasting scheme to public broadcast television is a “pay-per-view” television system where a viewer may select a program to view without commercials by paying a fee for the particular program. The pay-per-view paradigm provides a viewer with two options: 1) pay a fee to watch the program without commercials; or 2) pay no fee and not watch the program.

This pay-per-view system therefore provides no alternative to a viewer of watching the program with commercials by paying a reduced fee. In essence, a viewer has no choice in paying a fee if the viewer wishes to watch the program and watch commercials in a pay-per view system. The viewer has no option.

A need therefore exists that provides a viewer with an option on a per-program basis to pay to view a program without commercials or not pay to view a program with commercials. This need exists for both audio and visual programming.

### SUMMARY OF THE INVENTION

In one embodiment, the present invention provides for a method for providing content from a content provider to a viewer over a data network where the content is being associated with an option. The method offers to the viewer an option where the option is a choice between a first choice, of viewing the content without an advertisement being displayed during the content by making a choice compensation to the content provider from the viewer; and a second choice, of viewing the content with the advertisement being displayed during the content by not making the choice compensation to the content provider from the viewer. The viewer selects the first choice or the second choice and communicates the option selected to the content provider. Then the content is provided to the viewer based on the option selected.

In alternative embodiments, a system, computer-readable medium, and an electronic signal that performs or contains instructions for performing the methodology described above is also provided by the present invention.

Other features and advantages of the invention will become apparent to one with skill in the art upon examination of the following figures and detailed description. It is intended that all such features and advantages be included within this description.

### BRIEF DESCRIPTION OF THE FIGURES

The invention may be better understood with reference to the following Figures. The components in the Figures are not necessarily to scale, emphasis instead being placed upon clearly illustrating the principles of the present invention. Moreover, in the Figures, like reference numerals designate corresponding parts throughout the several views.

FIG. 1 is a block diagram view of an embodiment of the present invention;

FIG. 2 is a block diagram of an embodiment of the system of the present invention;

FIG. 3 is a block diagram view of an embodiment of the system of the present invention for visual content;

FIG. 4 is a block diagram view of an embodiment of the system of the present invention for audio content;

FIG. 5 is a flow chart of an embodiment of the methodology of the present invention for visual content;

FIG. 6 is a flow chart of an embodiment of the methodology of the present invention for audio content; and

FIG. 7 is a block diagram view of an embodiment of a computer system implementing an embodiment of the methodology of the present invention.

### DETAILED DESCRIPTION OF THE PREFERRED EMBODIMENT

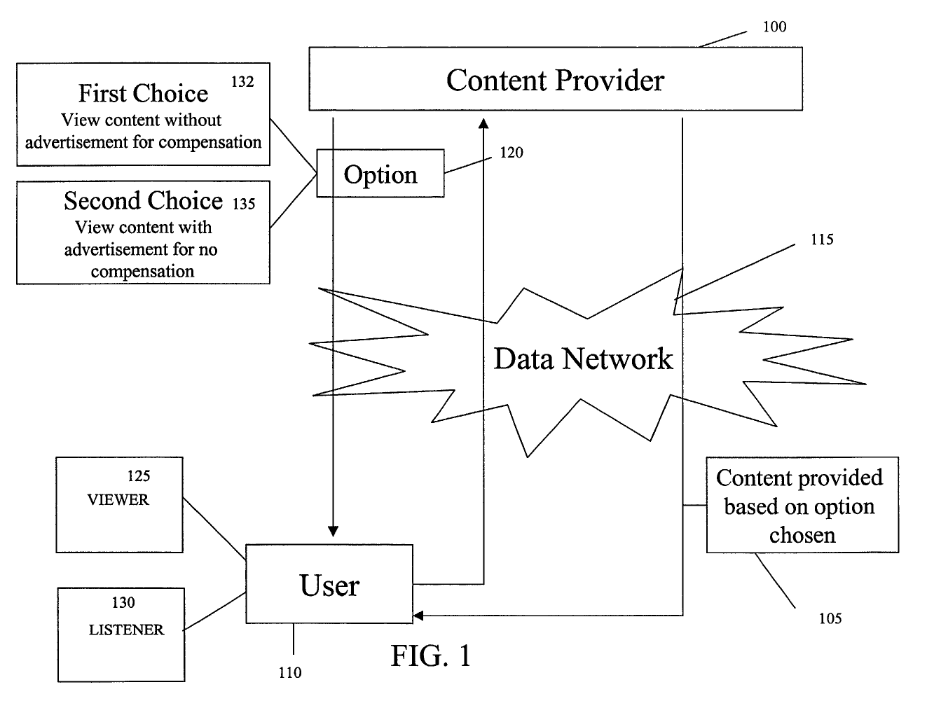

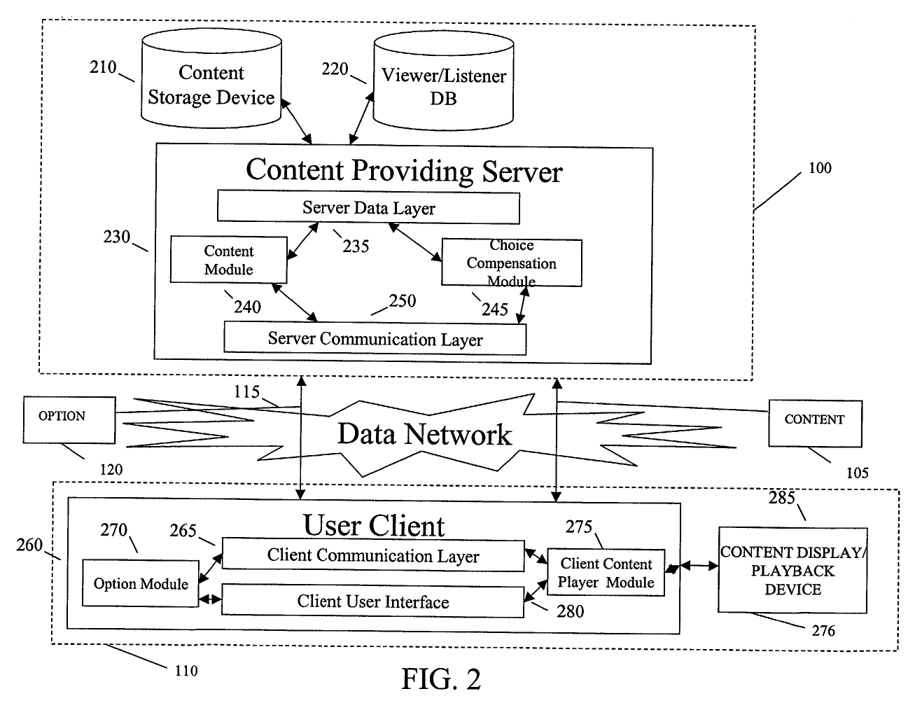

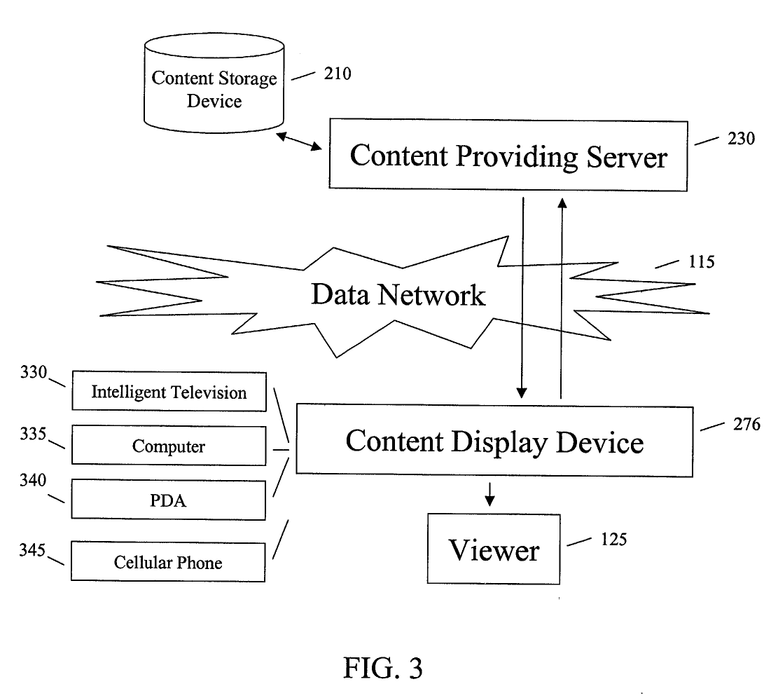

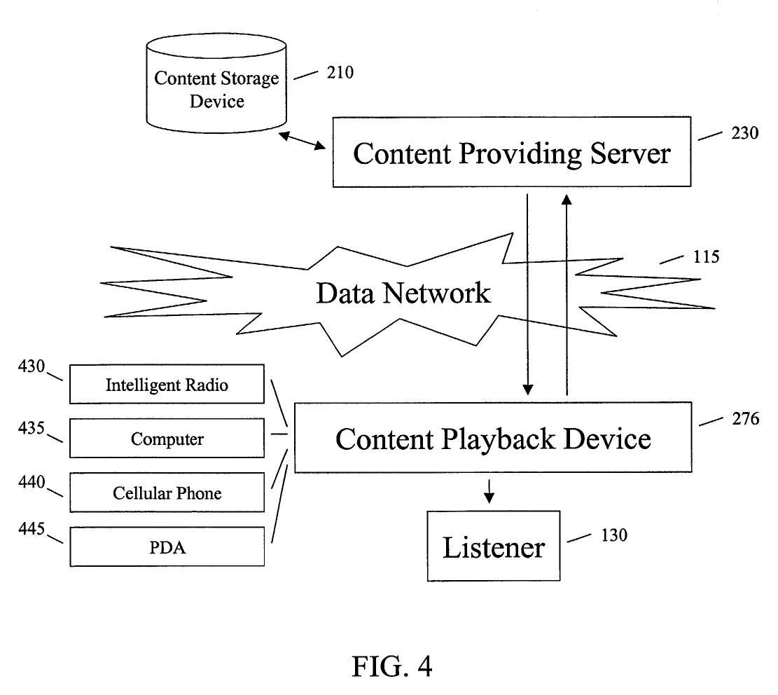

FIG. 1 is a block diagram view of an embodiment of the of the present invention. In FIG. 1, a content provider 100 is systematically shown to be sending content 105 to a user 110 over a data network 115 based on an option 120 chosen by the user 110. The content provider 100 may be any entity that distributes content, such as advertisements, movies, sporting events, situation comedies, drama series, miniseries or the like. A content provider 100 may be a broadcaster or a content creator such as Time Warner® or similar entities. The content 105 is provided through the data network 115. It is understood that the data network is any communication system that is able to transmit and receive data (i.e. information in numerical form that can be digitally transmitted or processed). In one embodiment, the data network is the Internet. In alternative embodiments, the data network is a LANs, WANs, or other means for communicating between devices that can transmit data. The user 110 may be a viewer 125, in the case of visual content, or a listener 130, in the case of audio content. The content 105 includes both motion picture content (i.e. a series of pictures projected on a screen in rapid succession with objects shown in successive positions slightly changed so as to produce the optical effect of a continuous picture in which the objects move) or static content such as a still photograph or other image. The user 110 would typically receive the content 105 through some type of content display device (276 of FIG. 3) in the case of visual content or a content playback device (276 of FIG. 4) in the case of audio content. The content provider 100 would typically have some type of content providing server (230 of FIG. 2) that distributes the content 105 from a content storage device (210 of FIG. 2) to the user 110 through the data network 115. Associated with the content 105 is an option 120. By associated, it is understood to mean that the option 120 may be provided with the content 105 in the same stream of information as the content 105 or may be delivered to the user 110 independent of the content 105 (i.e. through a different communication means) yet the option 120 is related to the particular content 105. The option 120 is a choice that is offered to the user 110, typically through a content display device 276 or a content playback device 276 of FIGS. 3 and 4, respectively. A first choice 132 is for the user 110 to view the content 105 without any advertising displayed during the content 105. When the first choice 132 is chosen, a choice compensation (e.g. a fee paid to the content provider 100 from the user 110) is made. The option 120 also includes a second choice 135 where the user may view the content 105 with advertisements being displayed during the content 105 by not making any choice compensation to the content provider 100 from the user 110. The option 120 thereby permits the user 110 to choose, on a content-by-content basis, whether or not the user 110 wishes to view advertisements during the content. Thus, for example, a user viewing a television situation comedy such as “Seinfeld” has an option of paying a choice compensation to view “Seinfeld” without any advertisements and thereby making the first choice 132; or viewing “Seinfeld” with advertisements and paying no choice compensation to thereby choose the second choice 135. By providing this option 120, the user is permitted to choose whether he/she has less time and therefore chooses the first choice 132 or has more time and therefore chooses the second choice 135. A user 110 may therefore pay the choice compensation when the user has less time. This is unlike conventional public broadcast, pay-per-view or cable systems where a user has no choice in whether to pay to not view advertisements or not pay and view advertisements. This choice or option provides the freedom to the user to make more efficient use of his or her time or money and also permits a user 110 not to miss programs by turning a television channel in order to avoid advertisements. This option also increases television audiences by permitting many viewers who dislike television, due to the amount of commercials, to spend more time viewing television by choosing the first choice (132).

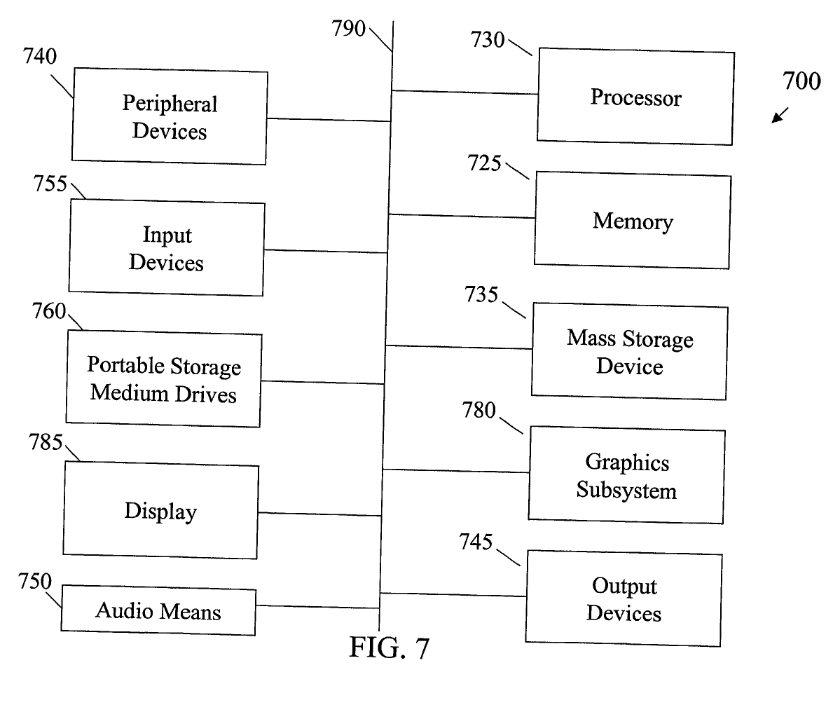

In use, the embodiment of FIG. 1 operates as follows. A content provider 100 has access to content 105 from some type of content storage device (210 of FIG. 2) that the content provider 100 is able to retrieve. That content storage device may be part of the content provider (such as on a database in communication with the content provider should the content provider be a server) or may be remotely located yet be accessible by the content provider 100. In one embodiment, the content provider is a computer system (FIG. 7) that is able to retrieve content 105 from a remote location to a data network such as the Internet. Once the content provider retrieves the content 105, the content provider 100 provides the option 120 to the user 110 prior to sending the content 105 to the user. It is noted that the option 120 need not be sent along with the content 105, but instead may be sent separately to the user 110. Alternatively, the option 120 may be sent with the content 105 together. It is only necessary that the option 120 be provided to the user in relation to or associated with the content 105. That is, in providing the option 120 to a user 110, the user is provided with the first choice (132) or the second choice 135 to view with a particular content 105. Thus, it is only necessary for the user 110 to know which content 105 the option 120 is being associated with. Thus, at this point, a user 110 receives an option 120 associated with a content 105. The user 110 typically has a content display device (276 of FIG. 3) such as an intelligent TV, a personal digital assistant, a cellular phone or a computer that is able to receive and display images. It is understood that this content display device is used to receive visual content, as opposed to audio content which uses a content playback device as discussed further below. It is further understood that the operation of the embodiment depicted in FIG. 1 also applies for receiving audio content even though this embodiment relates purely to the reception of visual content. The user therefore receives the option 120 on a content display device. The user 110 therefore would determine which content 105 the user wishes to view and provide that information to the content provider 100 over the data network 115 using any type of input devices described with relation to the computer system of FIG. 7. Upon receiving the content 105 that the user 110 wishes to view, the content provider 100 provides the option 120 to the user on the content display device 276. That option 120 permits the user to choose the first choice or the second choice associated with the content. Again, the first choice permits the user to view the content 105 without an advertisement being displayed on the content display device during the content. The first choice requires the user to agree to provide a choice compensation to the content provider in exchange for viewing the content 105 without any advertisement. optionally, the user 110 may make a second choice of viewing the content 105 with the advertisements being displayed on the content display device during the content. If the viewer chooses the second choice, no compensation is required to be sent from the content provider to the viewer. The amount of the choice compensation is determined by the content provider 100 and is typically displayed, in one embodiment, with the option 120. Thus, in one embodiment, the content provider 100, upon receiving the content 105 from the user 110 that the user wishes to view, sends to the user 110 through the data network 115 the option 120 along with the amount of the choice compensation. The choice compensation is typically determined in a variety of manners. In one embodiment, the choice compensation is based on the supply and demand per user depending on the demographics of the user. In another embodiment, the choice compensation is determined based on the ratings of the content being supplied. In still another embodiment, the choice compensation is based on viewing habits of the user 110. It is noted that the method of determining the choice compensation is separate and apart from the requirement that a choice compensation be made should the user choose the first choice (132). The user 110 therefore enters the first or second choice into the content display device and returns that information to the content provider 100 through the data network 115. It is understood that in other embodiments, the user may communicate his/her choice in any means to alert the content provider 100 that the user 110 wishes to make a first choice or a second choice. Thus, the user may, in other embodiments, use other communication means such as a telephone, a facsimile machine, or the like to inform the content provider 100 of the option 120 chosen. Upon receiving the option chosen by the user 110, the content provider 100 provides the content 105 to the user 110.

Again, the methodology shown in FIG. 1 alleviates the problems associated with prior broadcast paradigms in that a user 110 is permitted to make an option when receiving the content. No longer does a user have limited options on viewing content as in the past. In the past, a user only had the option of viewing content without advertisement by paying a fee, and if the fee was not paid, the content could not be viewed. Now, the content may be viewed even without paying a fee by allowing the advertisements to be shown. By providing this option, television viewing audiences are increased, efficient use of a viewer's time is maximized (since advertisements need not be watched should the first choice be chosen) and the user need not continuously change channels during advertisements should he/she choose not to do so. Such an improvement will increase television audiences and make television viewing a much more pleasurable experience.

FIG. 2 is a block diagram view of an embodiment of the system of the present invention. In FIG. 2, the content provider 100 is in communication with the user 110 over the data network 115, as previously shown in FIG. 1. However, in this embodiment, an additional embodiment of a system enabling the methodology of the present is shown. In this embodiment, the content provider 100 contains a content storage device 210 and a viewer/listener database 220 that is in communication with a content providing server 230. While these three elements are shown within the content provider 100, it is understood that the content storage device 210, the viewer/listener database 220 and the content providing server 230 may be in distinct and remote locations. It is necessary that these elements be able to communicate and exchange information, but they need not be located at one geographic location. In one embodiment, the content storage device 210 is a memory device located on the content providing server. The content storage device 210 may be one of any of the memory devices or storage devices described with reference to FIG. 7 below. The viewer/listener database 220 is any commonly-known database, such as Oracle, Informix, SQL or Sybase database. Again, the database 220 need only be in communication with the content providing server 230, but not need be at the same location. The content providing server, in one embodiment, is the computer system of FIG. 7. Contained within the content providing server 230 are software modules 235, 240, 250 and 245. These software modules contain computer instructions written in well-known computer languages such as C, C++, Java, Visual Basic or other computer programming languages well known in the art. The content module 240 is used to retrieve the content from content storage device 210 through the server data layer 235 and send the content 105 through the server communication layer 250 to the user/client 260. The server data layer 235 is used to communicate with the content storage device 210 and viewer/listener database 220. The choice compensation module 245 is used to determine the choice compensation based on the content and user in order to provide the choice compensation with the option 120. The choice compensation module 245 is in communication with the server communication layer 250 and the server data layer 235. Through the server data layer 235, the choice compensation module 245 is able to retrieve user information from the viewer/listener database 220 in order to determine a choice compensation should the user 110 determine a first choice of the option 120. The choice compensation module 245 is also able to update the viewer/listener database 220 upon selection of certain content or options in order to maintain viewing habits and demographics of the user 110. The user 110, in this embodiment, contains a user client 260, a content display/content playback device 276. The user/client 260, in one embodiment, is a computer system as depicted in FIG. 7 below. As part of that computer system, the user/client has software modules 270, 265, 275 and 280 that contain computer instructions for communicating with the content provider 100. Again, the software modules 270, 265, 275 and 280 are computer instructions much like the modules 235, 240, 245, and 250 described above. The option module 270 contains the first choice and second choice of the option 120 to display to the user on the content display/content playback device 276. The user enters the first choice or the second choice whereby the option module 270 communicates, through the client communication layer 265 to the choice compensation module 245 through the server communication layer 250, the results of the option chosen. It is noted that various alternative embodiments may have the content being delivered with the choice compensation module to the option module prior to the option module offering the option to the user. In this manner, the user views the choice compensation required to be paid to the content provider should the first choice be chosen. Upon choosing the first choice, that choice is returned to the choice compensation module and the content is delivered through the content module 240 to the user client 260. In alternative embodiments, the content 105 is delivered with the choice compensation so that the content may be played immediately upon making the option by the user. The client user interface 280 is used to interface between the user client 260 and the content display/playback device 276. The client content player module 275 is used to initiate the content 105 being played on the content display/playback device 276.

In use, the embodiment of FIG. 2 begins by the user 110 determining which content 105 the user wishes to view. In another embodiment, the content is automatically sent to the user based on prior viewing habits or a random content selection process. Once the user chooses a content, or simultaneously with choosing a content, the user determines an option, either the first choice or the second choice, for viewing the content without commercials with a choice compensation, or with commercials without a choice compensation, respectively. Upon entering its choice in the content display/playback device, the choice is received by the option module 270 and sent through the client communication layer 265 through the data network 115 and to the content providing server 230. Once at the content providing server 230, the server communication layer 250 receives the option entered by the user and communicates with the choice compensation module 245 to ensure that the user is charged for the option chosen. Simultaneously, the content module 240 is in communication with the server communication layer 250 to retrieve the content selected from the content storage device 210 to be sent through the data network 115 to the user client 260 to the user 110. Again, the content 105 may already reside, in alternative embodiments, at the user client 260 at the time that the option is selected by the user. The user therefore receives the content 105 upon providing the option and is able to view the content 105 with the option of paying a choice compensation to view the content without advertisements or to view the content with advertisements and paying no choice compensation.

FIG. 3 is a block diagram view of an embodiment of the system of the present invention. In FIG. 3, the system of FIG. 2 is described with specific particularity to visual content being shown through a content display device 276. In alternative embodiments, the content display device 276 may take the embodiment of an intelligent television 330, a computer 335, a personal digital assistant 340 or a cellular phone 345. The intelligent television 330 is any standard television that is able to communicate with the data network. Typically, in one embodiment, the intelligent television has a processor that is able to control data that is received and transmitted through a data network 115. The computer 335 is any standard computer such as the computer described with regard to FIG. 7 below. The personal digital assistant (PDA) 340 is a conventional hand-held electronic device that is able to communicate with the data network to exchange data through both wire or wireless technology. One example of a PDA is a Palm Pilot® manufactured by 3COM Corporation of Santa Clara, Calif. In an alternative embodiment, the content display device 276 is a cellular phone 345 that is able to communicate with a data network 115 and provide the visual content to a viewer 125. In use, the embodiment of FIG. 3 operates like the embodiment of FIG. 2.

FIG. 4 is a block diagram view of an embodiment of the system of the present invention for use with audio content. In FIG. 4, the content playback device 276 has alternative embodiments such as in intelligent radio 430, a computer 435, a cellular phone 440 or a PDA 445. Again, much like the embodiment of FIG. 3, these embodiments are all able to communicate with the data network in order to receive the audio content from the content providing server 230 through a data network 115.

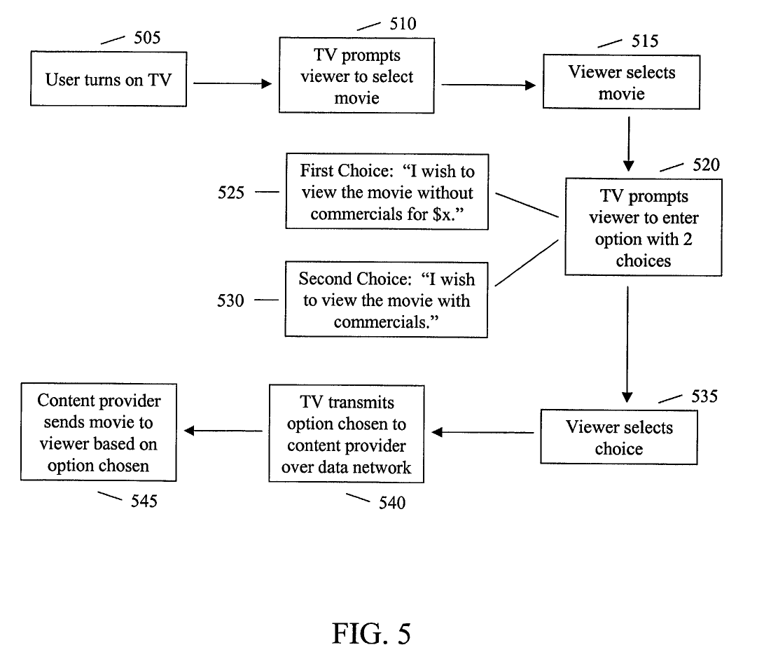

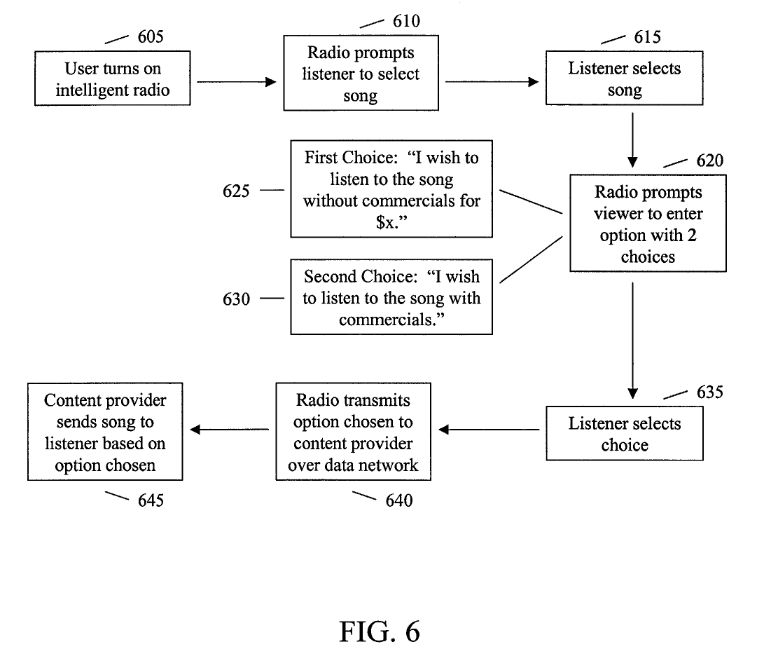

FIG. 5 is a flow chart of an embodiment of the methodology of the present invention. FIG. 5 depicts the flow chart of a method for providing the content from a content provider to a viewer over a data network for visual content. It is noted that FIG. 5 does not depict an embodiment of the methodology for providing audio content (shown in FIG. 6). In FIG. 5, a user (i.e. a viewer) turns on an intelligent television at step 505 of the flow chart in FIG. 5. The television is an intelligent television as described above. Once the intelligent television is turned on, the intelligent television at step 510 prompts the viewer to select content (e.g. a movie in the embodiment of FIG. 5). Then at step 515, the viewer selects the movie to be viewed. After the selection, at step 520, the intelligent television prompts the viewer to enter an option based on two choices: (1) a first choice at step 525 that provides that the viewer wishes to view the movie without commercials for a choice compensation of $X (e.g. an amount of money or other type of compensation); or (2) a second choice at 530 that the viewer wishes to view the movie with commercials for no additional charge. It is noted that while this embodiment has the user/viewer first selecting a movie and then providing an option, alternative embodiments could permit the user to select the movie and option at the same time. After the intelligent television prompts the viewer to enter an option at 520, the viewer selects a choice at 535 and the intelligent television transmits the option to a content provider over a data network at step 540. Once the option is received by the content provider, the content provider sends the movie to the viewer based on the option chosen at step 545.

FIG. 6 is the flow chart of an embodiment of the methodology of the present invention for audio content. In FIG. 6, the user (i.e. listener) turns on an intelligent radio at step 605. It is understood that an intelligent radio is a radio that is able to transmit and receive audio signals over a data network. At step 610, the intelligent radio prompts a listener to select audio content (e.g. a song). Then at step 615, the listener selects the song and then the intelligent radio prompts the listener to enter an option at step 620 by asking the listener to choose between two choices: (1) a first choice at step 625 of listening to the song without audio commercials for a choice compensation of $X (an amount of money or other compensation); or (2) a second choice at 630 of the listener listening to a song with commercials for no additional fee. The listener selects a choice at step 635 and the radio transmits that option selected by the listener to the content provider over the data network at step 640. The content provider then sends the song to the listener based on the action chosen at step 645.

FIG. 7 is a block diagram of a computer system used for implementing an embodiment of the method of the present invention. The computer system 700 includes a processor 730 for executing program instructions stored in a memory 725. In some embodiments, processor 730 includes a single microprocessor, while in others, processor 730 includes a plurality of microprocessors to define a multi-processor system. The memory 725 stores instructions and data for execution by processor 730, including instructions and data for performing the methods described above. Depending on the extent of software implementation in computer system 700, the memory 725 stores executable code when in operation. The memory 725 includes, for example, banks of read-only memory (ROM), dynamic random access memory (DRAM) as well as high-speed cache memory.

In FIG. 7, within computer system 700, an operating system comprises program instruction sequences that provide services for accessing, communicating with, and controlling computer system 700. The operating system provides a software platform upon which application programs may execute, in a manner readily understood by those skilled in the art. The computer system 700 further comprises one or more applications having program instruction sequences for providing the method of providing content with an option of the present invention.

In FIG. 7, the computer system 700 incorporates any combination of additional devices. These include, but are not limited to, a mass storage device 735, one or more peripheral devices 740, an audio means 750, one or more input devices 755, one or more portable storage medium drives 760, a graphics subsystem 780, a display 785, and one or more output devices 745. The various components are connected via an appropriate bus 790 as known by those skilled in the art. In alternative embodiments, the components are connected through other communications media known in the art. In one example, processor 730 and memory 725 are connected via a local microprocessor bus; while mass storage device 735, peripheral devices 740, portable storage medium drives 760, and graphics subsystem 780 are connected via one or more input/output buses.

In FIG. 7, mass storage device 735 is implemented as fixed and/or removable media, for example, as a magnetic, optical, or magneto-optical disk drive. The drive is preferably a non-volatile storage device for storing data and instructions for use by processor 730. In some embodiments, mass storage device 735 stores client and server information, code for carrying out methods in accordance with exemplary embodiments of the invention, and computer instructions for processor 730. In other embodiments, computer instructions for performing methods in accordance with exemplary embodiments of the invention also are stored in processor 730. The computer instructions are programmed in a suitable language such as Java or C++.

In FIG. 7, the portable storage medium drives 760, in some embodiments, operates in conjunction with a portable non-volatile storage medium, such as a floppy disk, CD-ROM, or other computer-readable medium, to input and output data and code to and from the computer system 700. In some embodiments, methods performed in accordance with exemplary embodiments of the invention are implemented using computer instructions that are stored on such a portable medium and input to the computer system 700 via portable storage medium drives 760.

In FIG. 7, the peripheral devices 740 include any type of computer support device, such as an input/output (I/O) interface, to add functionality to computer system 700. In one example, the peripheral devices include a network interface card for interfacing the server to a network, a modem, and the like. The peripheral devices also include input devices to provide a portion of a user interface and may include an alphanumeric keypad or a pointing device such as a mouse, a trackball, a stylus, or cursor direction keys. The I/O interface comprises conventional circuitry for controlling input devices and performing particular signal conversions upon I/O data. The I/O interface may include, for example, a keyboard controller, a serial port controller, and/or digital signal processing circuitry.

In FIG. 7, the graphics subsystem 780 and the display 785 provide output alternatives of the system. The graphics subsystem 780 and display 785 include conventional circuitry for operating upon and outputting data to be displayed, where such circuitry preferably includes a graphics processor, a frame buffer, and display driving circuitry. The display 785 may include a cathode ray tube (CRT) display, a liquid crystal display (LCD), or other suitable devices. The display 785 preferably can display at least 256 colors. The graphics subsystem 780 receives textual and graphical information and processes the information for output to the display 785. A video card in the computer system 700 also comprises a part of graphics subsystem 780 and also preferably supports at least 256 colors. For optimal results in viewing digital images, the user should use a video card and monitor that can display the True Color (24 bit color) setting. This setting enables the user to view digital images with photographic image quality.

In FIG. 7, audio means 750 preferably includes a sound card that receives audio signals from a peripheral microphone. In addition, audio means 750 may include a processor for processing sound. The signals can be processed by the processor in audio means 750 of computer system 700 and passed to other devices as, for example, streaming audio signals.

In some embodiments, programs for performing methods in accordance with exemplary embodiments of the invention are embodied as computer program products. These generally include a storage medium or media having instructions stored thereon used to program a computer to perform the methods described above. Examples of suitable storage medium or media include any type of disk including floppy disks, optical disks, DVDs, CD ROMs, magnetic optical disks, RAMs, EPROMs, EEPROMs, magnetic or optical cards, hard disk, flash card, smart card, and other media.

Stored on one or more of the computer readable media, the program includes software for controlling both the hardware of a general purpose or specialized computer or microprocessor. This software also enables the computer or microprocessor to interact with a human or other mechanism utilizing the results of exemplary embodiments of the invention. Such software includes, but is not limited to, device drivers, operating systems and user applications. Preferably, such computer readable media further include software for performing the methods described above.

In certain other embodiments, a program for performing an exemplary method of the invention or an aspect thereof is situated on a carrier wave such as an electronic signal transferred over a data network. Suitable networks include the Internet, a frame relay network, an ATM network, a wide area network (WAN), or a local area network (LAN) . Those skilled in the art will recognize that merely transferring the program over the network, rather than executing the program on a computer system or other device, does not avoid the scope of the invention.

It should be emphasized that the above-described embodiments of the invention are merely possible examples of implementations set forth for a clear understanding of the principles of the invention. Variations and modifications may be made to the above-described embodiments of the invention without departing from the spirit and principles of the invention. All such modifications and variations are intended to be included herein within the scope of the invention and protected by the following claims.

What is claimed is:

1. A method for providing a content from a content provider to a viewer over a data network, the content being associated with an option, comprising:
offering to the viewer the option, the option being a choice between
a first choice of viewing the content without an advertisement being displayed during the content by making a choice compensation to the content provider from the viewer, and
a second choice of viewing the content with the advertisement being displayed during the content by not making the choice compensation to the content provider from the viewer;
selecting, by the viewer, the first choice or the second choice;
communicating the option selected to the content provider; and
providing the content, from the content provider to the viewer, based on the option selected.

2. The method of claim 1, wherein the step of offering the viewer the option further comprises:
offering the viewer the option over a content display device.

3. The method of claim 2, wherein the step of offering the viewer the option further comprises:
offering the viewer the option over an intelligent television.

4. The method of claim 2, wherein the step of offering the viewer the option further comprises:
offering the viewer the option over a computer.

5. The method of claim 2, wherein the step of offering the viewer the option further comprises:
offering the viewer the option over a personal digital assistant.

6. The method of claim 2, wherein the step of offering the viewer the option further comprises:
offering the viewer the option over a cellular telephone.

7. The method of claim 1, wherein the step of providing the content further comprises:
providing a movie.

8. The method of claim 1, wherein providing the content further comprises:
providing a sporting event.

9. The method of claim 1, wherein providing the content further comprises:
providing a situation comedy.

10. The method of claim 1, wherein providing the content further comprises:
providing a drama series.

11. The method of claim 1, wherein providing the content further comprises:
providing a news event.

13. The method of claim 1, wherein providing the content further comprises:
providing a miniseries.

14. The method of claim 1, wherein the step of selecting the first choice or the second choice further comprises:
transmitting, by the viewer, the first choice or the second choice selected by the viewer over the data network to the content provider.

15. The method of claim 1, wherein the step of offering the viewer the option further comprises:
making the choice compensation, the choice compensation being a fee paid to the content provider from the viewer.

16. The method of claim 1, further comprising:
offering to the viewer a third choice of viewing the content with an embedded advertisement being displayed during the content by making the choice compensation to the content provider from the viewer, the embedded advertisement being displayed as part of the content.

17. A system for providing a content from a content provider to a viewer over a data network, the content being associated with an option, comprising:
a content display device for displaying content;
a content providing server, the content providing server having a processor for communicating with the content display device and a content storage device; and
the content storage device, the content storage device having computer instructions stored thereon, that, when loaded into a computer, cause the computer to perform the method of:
offering to the viewer the option, the option being a choice between
a first choice of viewing the content without an advertisement being displayed during the content by making a choice compensation to the content provider from the viewer, and
a second choice of viewing the content with the advertisement being displayed during the content by not making the choice compensation to the content provider from the viewer;
selecting, by the viewer, the first choice or the second choice;
communicating the option selected to the content provider; and
providing the content, from the content provider to the viewer, based on the option selected.

18. A computer readable medium having computer instructions stored thereon that, when loaded into a computer system, cause the computer system to perform the method for providing a content from a content provider to a viewer over a data network, the content being associated with an option, the method comprising:
offering to the viewer the option, the option being a choice between
a first choice of viewing the content without an advertisement being displayed during the content by making a choice compensation to the content provider from the viewer, and
a second choice of viewing the content with the advertisement being displayed during the content by not making the choice compensation to the content provider from the viewer;
selecting, by the viewer, the first choice or the second choice;
communicating the option selected to the content provider; and
providing the content, from the content provider to the viewer, based on the option selected.

19. An electronic signal, comprising:
computer instructions that, when loaded into a computer, cause the computer to perform a method for providing a content from a content provider to a viewer over a data network, the content being associated with an option, the method comprising:
offering to the viewer the option, the option being a choice between
a first choice of viewing the content without an advertisement being displayed during the content by making a choice compensation to the content provider from the viewer, and
a second choice of viewing the content with the advertisement being displayed during the content by not making the choice compensation to the content provider from the viewer;
selecting, by the viewer, the first choice or the second choice;
communicating the option selected to the content provider; and
providing the content, from the content provider to the viewer, based on the option selected.

20. A method for providing a content from a content provider to a listener over a data network, the content being associated with an option, comprising:
offering to the listener the option, the option being a choice between
a first choice of listening to the content without an advertisement being played during the content by making a choice compensation to the content provider from the listener, and
a second choice of listening to the content with the advertisement being played during the content by not making the choice compensation to the content provider from the listener;
selecting, by the listener, the first choice or the second choice;
communicating the option selected to the content provider; and
providing the content, from the content provider to the listener, based on the option selected.

21. The method of claim 20, wherein the step of offering the listener the option further comprises:
offering the listener the option over a content playback device.

22. The method of claim 21, wherein the step of offering the listener the option further comprises:
offering the listener the option over an intelligent radio.

23. The method of claim 21, wherein the step of offering the listener the option further comprises:
offering the listener the option over a computer.

24. The method of claim 21, wherein the step of offering the listener the option further comprises:
offering the listener the option over a personal digital assistant.

25. The method of claim 21, wherein the step of offering the listener the option further comprises:
offering the listener the option over a cellular telephone.

26. A system for providing a content from a content provider to a listener over a data network, the content being associated with an option, comprising:
a content playback device for playing content;
a content providing server, the content providing server having a processor for communicating with the content playback device and a content storage device; and
the content storage device, the content storage device having computer instructions stored thereon, that, when loaded into a computer, cause the computer to perform the method of:
offering to the listener the option, the option being a choice between
a first choice of listening to the content without an advertisement being played during the content by making a choice compensation to the content provider from the listener, and
a second choice of listening to the content with the advertisement being played during the content by not making the choice compensation to the content provider from the listener;
selecting, by the listener, the first choice or the second choice;
communicating the option selected to the content provider; and
providing the content, from the content provider to the listener, based on the option selected.

27. A computer readable medium having computer instructions stored thereon that, when loaded into a computer system, cause the computer system to perform the method for providing a content from a content provider to a listener over a data network, the content being associated with an option, the method comprising:
offering to the listener the option, the option being a choice between
a first choice of listening to the content without an advertisement being played during the content by making a choice compensation to the content provider from the listener, and
a second choice of listening to the content with the advertisement being played during the content by not making the choice compensation to the content provider from the listener;
selecting, by the listener, the first choice or the second choice;
communicating the option selected to the content provider; and
providing the content, from the content provider to the listener, based on the option selected.

28. An electronic signal, comprising:
computer instructions that, when loaded into a computer, cause the computer to perform a method for providing a content from a content provider to a listener over a data network, the content being associated with an option, the method comprising:
offering to the listener the option, the option being a choice between
a first choice of listening to the content without an advertisement being played during the content by making a choice compensation to the content provider from the listener, and
a second choice of listening to the content with the advertisement being played during the content by not making the choice compensation to the content provider from the listener;
selecting, by the listener, the first choice or the second choice;
communicating the option selected to the content provider; and
providing the content, from the content provider to the listener, based on the option selected.
